(19) United States
(12) Patent Application Publication
(10) Pub. No.: US 2021/0390471 A1
(43) Pub. Date: Dec. 16, 2021

(54) RISK CONTROL EVENT AUTOMATIC PROCESSING METHOD AND APPARATUS

(71) Applicant: Advanced New Technologies Co., Ltd., Grand Cayman (KY)

(72) Inventors: Peng Zhang, Hangzhou (CN); Xinqi Wu, Hangzhou (CN); Zhixiong Yang, Hangzhou (CN); Ying Zhang, Hangzhou (CN)

(73) Assignee: Advanced New Technologies Co., Ltd., Grand Cayman (KY)

(21) Appl. No.: 17/461,111

(22) Filed: Aug. 30, 2021

Related U.S. Application Data
(63) Continuation of application No. 16/421,133, filed on May 23, 2019.
Application No. 16/421,133 is a continuation of application No. PCT/CN2018/078164, filed on Mar. 6, 2018.

(30) Foreign Application Priority Data
Mar. 9, 2017 (CN) 201710136278.5

(51) Int. Cl. G06Q 10/06; G06Q 20/02; G16Z 99/00; G06Q 20/40

(52) U.S. Cl. CPC G06Q 10/0635; G06Q 20/4016; G16Z 99/00; G06Q 20/02

(57) ABSTRACT

This specifications describes techniques for processing a risk control event. One example method includes identifying risk feature information associated with a risk control event; determining a risk determination result based on a pre-defined risk model and the risk feature information, wherein the risk determination result represents at least a determined risk level for the risk control event; identifying evidence information related to the risk determination result; and generating case closing information for the risk control event based on the risk determination result and the evidence information.

### CROSS-REFERENCE TO RELATED APPLICATIONS

This application is a continuation of U.S. application Ser. No. 16/421,133, filed May 23, 2019, which is a continuation of PCT Application No. PCT/CN2018/078164, filed on Mar. 6, 2018, which claims priority to Chinese Patent Application No. 201710136278.5, filed on Mar. 9, 2017, and each application is hereby incorporated by reference in its entirety.

### TECHNICAL FIELD

The present application relates to the field of computer software technologies, and in particular, to a risk control event automatic processing method and apparatus.

### BACKGROUND

On a risk control platform, many users report cases every day, and content reported each time can be considered as a risk control event. After receiving a risk control event, an examiner of the risk control platform examines the risk control event. The examiner usually determines the risk control event based on operation content, an environment, and a device of a user on the platform, for example, determines a category of the risk control event (for example, a case or a non-case, where different risk control events have different risks, a risk control event with a specified high risk level can be usually referred to as a case, and the other risk control events can be referred to as non-cases), etc. If necessary, the examiner communicates with the user for confirmation, and finally generates case closing information of the risk control event, to close the risk control event.

However, currently, the examiner determines a risk control event through manual analysis. Consequently, case closing efficiency is low, and in addition, the reliability of a determination result of the risk control event is hard to verify.

### SUMMARY

Implementations of the present application provide a risk control event automatic processing method and apparatus, to alleviate the following technical problems in the existing technology: Because an examiner of a security risk control platform determines a risk control event through manual analysis the case closing efficiency is low, and the reliability of a determination result of the risk control event is also hard to verify.

To alleviate the previous technical problem, the implementations of the present application are implemented as follows:

An implementation of the present application provides a risk control event automatic processing method, including: obtaining each piece of risk feature information of a current risk control event; determining a category of the current risk control event based on the risk feature information; obtaining evidence information corresponding to a determination result; and generating case closing information of the current risk control event based on the determination result and the evidence information.

An implementation of the present application provides a risk control event automatic processing apparatus, including: a first acquisition module, configured to obtain each piece of risk feature information of a current risk control event; a determining module, configured to determine a category of the current risk control event based on the risk feature information; a second acquisition module, configured to obtain evidence information corresponding to a determination result; and a generation module, configured to generate case closing information of the current risk control event based on the determination result and the evidence information.

The previous at least one technical solution used in the present implementation of the present application can achieve the following beneficial effects: The risk control event can be automatically processed, to further improve a case closing speed. In addition, the evidence information corresponding to the determination result of the risk control event can be automatically obtained, and therefore, it is convenient to verify the reliability of the determination result of the risk control event, and some or all problems in the existing technology can be alleviated.

### BRIEF DESCRIPTION OF DRAWINGS

To describe the technical solutions in the implementations of the present application or in the existing technology more clearly, the following briefly describes the accompanying drawings required for describing the implementations or the existing technology. Apparently, the accompanying drawings in the following description merely show some implementations of the present application, and a person of ordinary skill in the art can still derive other drawings from these accompanying drawings without creative efforts.

FIG. 1 is a schematic flowchart illustrating a risk control event automatic processing method, according to an implementation of the present application;

FIG. 2 is a schematic diagram illustrating an extended procedure corresponding to FIG. 1, according to an implementation of the present application;

FIG. 3 is a schematic diagram illustrating a decision tree, according to an implementation of the present application;

FIG. 4 is a schematic diagram illustrating decision paths on the decision tree in FIG. 3, according to an implementation of the present application;

FIG. 5 is a schematic diagram illustrating a comparison between case closing information generated based on the previous risk control event automatic processing method and case closing information in the existing technology, according to an implementation of the present application; and

FIG. 6 is a schematic structural diagram illustrating a risk control event automatic processing apparatus corresponding to FIG. 1, according to an implementation of the present application.

FIG. 7 is a flowchart illustrating an example of a computer-implemented method for processing a risk control event, according to an implementation of the present disclosure.

### DESCRIPTION OF IMPLEMENTATIONS

Implementations of the present application provide a risk control event automatic processing method and apparatus.

To make a person skilled in the art understand the technical solutions in the present application better, the following clearly and comprehensively describes the technical solutions in the implementations of the present application with reference to the accompanying drawings in the implementations of the present application. Apparently, the described implementations are merely some but not all of the implementations of the present application. All other implementations obtained by a person of ordinary skill in the art based on the implementations of the present application without creative efforts shall fall within the protection scope of the present application.

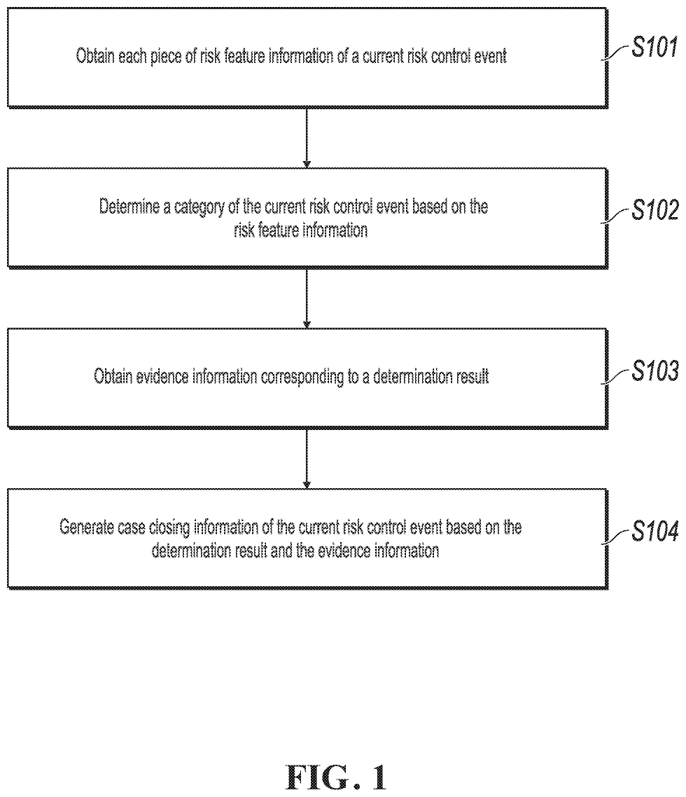

FIG. 1 is a schematic flowchart illustrating a risk control event automatic processing method, according to an implementation of the present application. From the perspective of a program, the present procedure can be executed by an application (APP), a personal computer (PC) side program, etc. From the perspective of a device, an execution body of the present procedure can include but is not limited to the following devices: a personal computer, a large-sized or medium-sized computer, a computer cluster, a mobile phone, a tablet computer, a smart wearable device, a vehicle machine, etc.

The procedure in FIG. 1 can include the following steps.

S101: Obtain each piece of risk feature information of a current risk control event.

In the present implementation of the present application, the risk control event can be obtained after a user reports a case, or can be obtained by actively monitoring a certain service.

An online shopping service is used as an example. When the user suspects that there is a problem with an online transaction of the user, the user can report a case to a corresponding risk control platform, and as such, the online transaction becomes a risk control event. Certainly, the risk control platform can alternatively actively monitor each online transaction of the user, and in this way, each online transaction becomes a risk control event.

In the present implementation of the present application, the risk feature information can be used to measure a risk of a risk control event. Therefore, the risk feature information can be used as a basis for determining the risk control event.

A risk feature corresponding to the risk feature information can be designed in advance based on a service. The online shopping service is still used as an example. The risk feature can be, for example, the number of historical transactions between users, a geographical location at which the user conducts a transaction, or a device used by the user to conduct a transaction, etc. In practice, the risk feature information can be a specific value of the risk feature corresponding to the risk feature information, or can be information used to determine the specific value, etc.

In practice, a risk feature can be designed based on a requirement, to improve effects of the solutions of the present application. Three possible requirements on the risk feature are listed as follows:

A “determinable” requirement means that the risk feature is suitable for determining of a case and is related to a risk category of the case. For example, the risk feature is “the number of historical transactions between users”. When the value is very large, it indicates that the user is familiar with the other party of a transaction, a risk is low, and the transaction is unlikely to be a case; otherwise, a risk is high, and the transaction is more likely to be a case.

An “understandable” requirement means that a meaning of the risk feature is easy to understand. For example, “the number of historical transactions between users” has a clear meaning.

An “evidence-available” requirement means that the risk feature can correspond to clear evidence information, and the evidence information is easy to obtain. For example, the risk feature is “the number of historical transactions between users”. Information about each corresponding historical transaction can be clearly and easily obtained, and used as corresponding evidence information.

S102: Determine a category of the current risk control event based on the risk feature information.

In the present implementation of the present application, different risk control events have different risks. Usually, a risk control event with a specified high risk level can be referred to as a case, and the other risk control events can be referred to as non-cases. Based on such a premise, the category of the risk control event can be a case or a non-case.

Further, the case or the non-case can be subdivided. For example, the case can be subdivided into “device lost-case” and “account stolen-case”; and the non-case can be subdivided into “performed by an acquaintance on behalf of the user-non-case” and “performed by the user-non-case”.

It is worthwhile to note that classifying the risk control event based on whether the risk control event is a case is merely an example classification method. There is another classification method. For example, a plurality of different risk level categories can be set, and each risk control event is classified into at least one of the risk level categories.

S103: Obtain evidence information corresponding to a determination result.

In the present implementation of the present application, the evidence information can be obtained based on a determining process, or can be obtained based on the risk feature information. The evidence information can be, for example, detailed information of the determining process or detailed information of the risk feature information. Assume that certain risk feature information is as follows: There are five historical transactions between users. Therefore, detailed information of the risk feature information can be transaction record details of the five transactions, etc.

If necessary, the reliability of the determination result of the corresponding risk control event can be verified based on the evidence information.

S104: Generate case closing information of the current risk control event based on the determination result and the evidence information.

In the present implementation of the present application, in addition to generating the case closing information, a countermeasure can be taken for the current risk control event based on the determination result. For example, if it is determined that the current risk control event is a case, countermeasures such as banning a transaction account and refusing to continue a transaction can be taken for the current risk control event, to ensure the transaction security.

Based on the method in FIG. 1, the risk control event can be automatically processed, to improve a case closing speed. In addition, the evidence information corresponding to the determination result of the risk control event can be automatically obtained, and therefore, it is convenient to verify the reliability of the determination result of the risk control event.

Based on the method in FIG. 1, the present implementation of the present application further provides some implementation solutions of the method and an extended solution. Description is provided below.

In the present implementation of the present application, in step S102, the determining a category of the current risk control event based on the risk feature information can include: obtaining a classifier obtained by performing training based on risk feature information of sample risk control events; and determining the category of the current risk control event by classifying the current risk control event based on the classifier and the risk feature information.

The classifier can be implemented in a plurality of methods. For example, the classifier can be implemented based on a decision tree, or the classifier can be implemented based on a neural network. The classifier is usually obtained by performing pre-training based on a plurality of sample risk control events.

Certainly, the category of the current risk control event can be determined without using the classifier. For example, a risk feature information blacklist can be predetermined. Then, the risk feature information of the current risk control event is matched with the blacklist. If the risk feature information of the current risk control event matches the blacklist, it is directly determined that the current risk control event is a case.

In the present implementation of the present application, as described above, the evidence information corresponding to the determination result can be obtained based on the risk feature information. In such a case, different risk feature information usually corresponds to different evidence information. When there are a small number of risk features, evidence information corresponding to all risk feature information of the current risk control event can be obtained indiscriminately. However, when there are a large number of risk features, it is inappropriate because a large amount of processing resources and time are consumed and costs are increased.

In consideration of such a problem, only evidence information corresponding to some relatively important risk feature information can be obtained. For example, in the present implementation of the present application, a contribution representation value can be used to measure the importance of the risk feature information. In step S103, the obtaining evidence information corresponding to a determination result can include: determining contribution representation values of the risk feature information; and obtaining the evidence information corresponding to the determination result based on the contribution representation values and the risk feature information corresponding to the contribution representation values.

The previous example is still used. The relatively important risk feature information can be determined by ranking contribution representation values or by comparing contribution representation values with a specified threshold.

For example, the relatively important risk feature information is determined by ranking the contribution feature values. The obtaining evidence information corresponding to a determination result can include: ranking the risk feature information based on the determined contribution representation values of the risk feature information; and obtaining, based on a ranking result, evidence information corresponding to risk feature information with top N contribution representation values, and using the evidence information as the evidence information corresponding to the determination result, where N is an integer not less than 1.

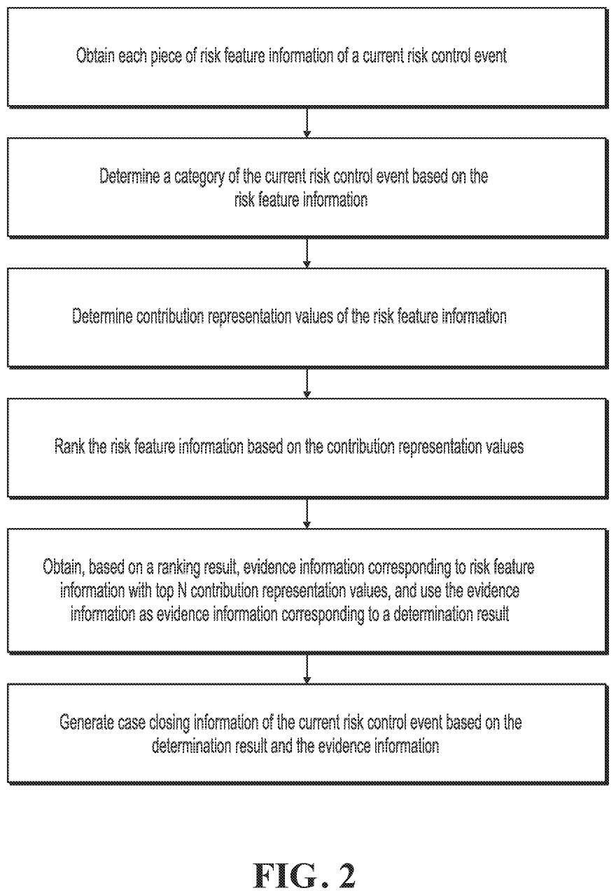

Based on the previous idea, the procedure in FIG. 1 can be extended to obtain a more detailed procedure, as shown in FIG. 2.

FIG. 2 is a schematic diagram illustrating an extended procedure corresponding to FIG. 1, according to an implementation of the present application.

The procedure in FIG. 2 can include the following steps: obtaining each piece of risk feature information of a current risk control event; determining a category of the current risk control event based on the risk feature information; determining contribution representation values of the risk feature information; ranking the risk feature information based on the contribution representation values; obtaining, based on a ranking result, evidence information corresponding to risk feature information with top N contribution representation values, and using the evidence information as evidence information corresponding to a determination result; and generating case closing information of the current risk control event based on the determination result and the evidence information.

Compared with the procedure in FIG. 1, the procedure in FIG. 2 focuses on determining of the contribution representation values of the risk feature information. Detailed description is provided below.

In the present implementation of the present application, the contribution representation values of the risk feature information can be determined based on one aspect or a plurality of aspects of factors. Several factors are listed as examples below.

First: Evidence importance. As described above, after the category of the current risk control event is determined, the evidence information needs to be further obtained. In other words, evidence needs to be further provided. The evidence importance can reflect the importance of the evidence information corresponding to the risk feature information.

Second: Category determination contribution. The category determination contribution can reflect the contribution of the risk feature information in a process of determining the category of the risk control event.

Third: Feature dimension contribution. The feature dimension contribution can reflect the contribution of a risk feature corresponding to the risk feature information to the result of determining the category of the risk control event, and the contribution can be independent of the determining process.

Fourth: Feature anomaly. The feature anomaly can reflect the anomaly of the risk feature information. For example, the feature anomaly can indicate the degree to which the risk feature information deviates from a standard value used in the determining process, etc. The standard value is used to be compared with the risk feature information, to determine how to select a branch in the determining process.

The previous factors can also be represented by corresponding representation values, to facilitate operations. The previous four factors are used as an example. The determining contribution representation values of the risk feature information can include: determining at least one of the following specific representation values of the risk feature information: an evidence importance representation value, a category determination contribution representation value, a feature dimension contribution representation value, and a feature anomaly representation value; and determining the contribution representation values of the risk feature information based on determined specific representation values.

In addition, for a risk control event with determined risk feature information, a contribution representation value of the risk feature information of the risk control event is a contribution representation value of a risk feature corresponding to the risk feature information, because a risk feature of the risk control event at this time is not a variable but is the risk feature information.

For ease of understanding, a solution that can be used to determine the previous representation values is described based on an actual application scenario.

In such a scenario, the previous classifier performs classification by using a decision tree. To be specific, in step S102, the category of the current risk control event is determined based on the decision tree. At least some nodes on the decision tree include a risk feature corresponding to the risk feature information.

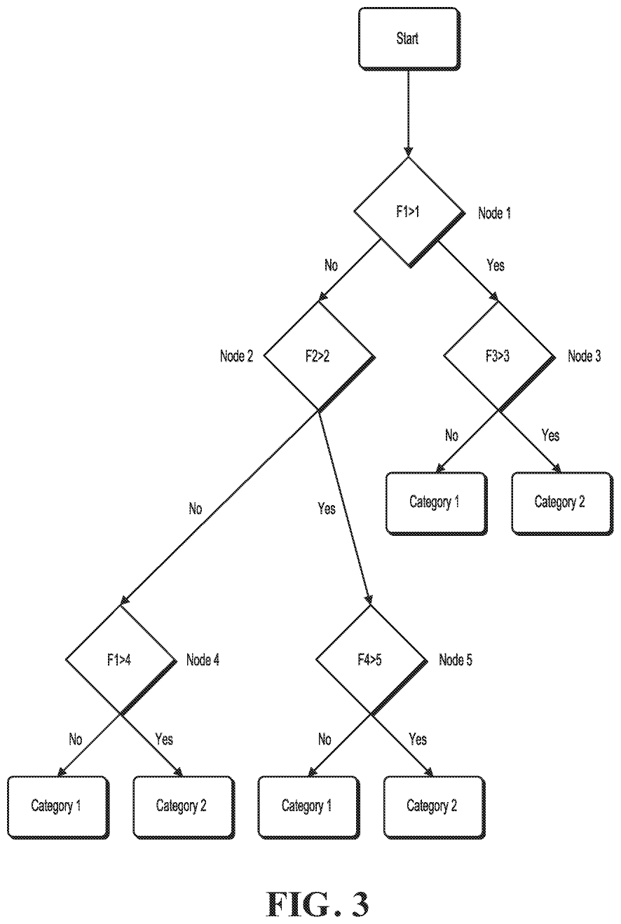

FIG. 3 is a schematic diagram illustrating the previous decision tree, according to an implementation of the present application. In FIG. 3, the decision tree includes five nodes. Each node includes one risk feature and a standard value corresponding to the risk feature. Leaf nodes on the decision tree are classified into two categories: category 1 and category 2. Information input into the decision tree is usually determined as category 1 or category 2. In step S102, the obtained risk feature information of the current risk control event can be input into the decision tree to determine the category of the current risk control event.

Node 1 is used as an example, and “F₁>1” in node 1 means that a risk feature included in node 1 is denoted as F₁, and a corresponding standard value is 1; when input risk feature information of F₁ is not greater than 1, the left branch of node 1 is selected, in other words, a next node is node 2; and when input risk feature information of F₁ is greater than 1, the right branch of node 1 is selected, in other words, a next node is node 3.

For ease of description, the evidence importance representation value is denoted as FCₖ(ƒ), the category determination contribution representation value is denoted as FC_{c}(ƒ), the feature dimension contribution representation value is denoted as FC_{F}(ƒ), and the feature anomaly representation value is denoted as FO_{C}(ƒ), where ƒ denotes a risk feature, and for a certain risk control event, ƒ can alternatively denote risk feature information corresponding to the risk feature. At least one determining method of each of the several representation values is described.

1. A determining method for the evidence importance representation value FCₖ(ƒ). The evidence importance representation value FCₖ(ƒ) can usually be determined based on prior field knowledge, and an expert in the field can provide the importance of each risk feature ƒ to subsequent evidence-providing. For example FCₖ(ƒ)∈[0,1] can be described. Greater importance of the risk feature ƒ to the subsequent evidence-providing can correspond to a larger value of FCₖ(ƒ) in a value interval [0,1].

2. A determining method for the category determination contribution representation value FC_{c}(ƒ). The category determination contribution representation value of the risk feature information of the current risk control event can be determined in the following method: determining a decision path corresponding to the determination result on the decision tree; and determining the category determination contribution representation value of the risk feature information of the current risk control event based on density change information of sample risk control events of a specified category that are before and after a specific node included on the decision path, where the specific node includes the risk feature corresponding to the risk feature information.

With reference to FIG. 3, assume that category 1 is case, and category 2 is non-case. The previous specified category can usually be a case, and the density change information of the sample risk control events of the specified category is case density change information.

A case density can be, for example, data such as a case proportion. The case proportion is used as an example. Assume that node 2 is on the decision path. Before node 2 performs filtering, a case proportion of the sample risk control events is 1/10; and after node 2 performs filtering, the case proportion of the sample risk control events is increased to 1/2. An increase from 1/10 to 1/2 can be used as the density change information.

After a node included on the decision path is passed, the degree to which the case density is increased can reflect the degree to which a risk feature included in the node contributes to classification determining. For any risk feature, the contribution of the risk feature to classification can be determined based on contributions of the risk feature to classification on at least some nodes including the risk feature among all nodes included on the decision path. There can be a plurality of determining methods. For example, the contributions of the risk feature to classification on at least some nodes including the risk feature can be accumulated or added through weighting.

For ease of understanding, description is provided by using formulas.

Assume that node n on the decision tree includes the risk feature ƒ and node n is included on the decision path and there are two categories that are respectively indicated by y=0 and y=1, the contribution of the risk feature ƒ to classification on node n is as follows:

FC_{c}ⁿ(ƒ)=Pⁿ(y=C(x)|F,ƒ)−Pⁿ(y=C(x)|F) (Formula 1)

F denotes a risk feature set included in an upstream node of node n, C(x) denotes a classification result of a current risk control event x, Pⁿ(y=C(x)|F) denotes a proportion of risk control events (for example, cases) of a specified category to all sample risk control events that enter node n after the upstream node performs filtering, and Pⁿ(y=C(x)|F,ƒ) denotes a proportion of risk control events (for example, cases) of the specified category to all sample risk control events obtained after node n performs filtering.

Further, the contribution of the risk feature ƒ can be obtained by accumulating contributions corresponding to all nodes on the decision path:

For the risk feature ƒ, the category determination contribution representation value FC_{c}(ƒ) can be as follows:

FC_{c}(ƒ)=Σ_{n∈R(x),ƒ=F}_{ₙ}FC_{c}ⁿ(ƒ) (Formula 2)

R(x) denotes a decision path that x passes through on the decision tree. A standard value of ƒ included in node n on the decision tree is Fₙ.

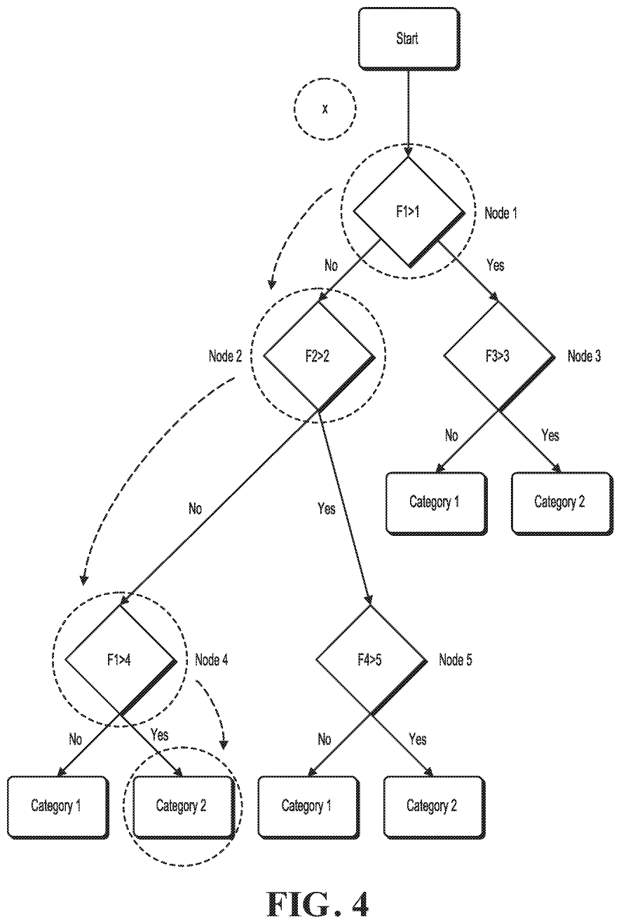

FIG. 4 is a schematic diagram illustrating decision paths on the decision tree in FIG. 3, according to an implementation of the present application.

In FIG. 4, a decision path that x passes through is as follows: Each piece of risk feature information of x is input into node 1, and passes node 2 and node 4 to a leaf node corresponding category 2. According to formula 2, a category determination contribution representation value of risk feature F₁ is FC₁(F₁)+FC₄(F₁), that is, a category determination contribution representation value of risk feature information corresponding to risk feature F₁ in the risk feature information of x; a category determination contribution representation value of risk feature F₂ is FC₂(F₂), that is, a category determination contribution representation value of risk feature information corresponding to risk feature F₂ in the risk feature information of x; and risk features F₃ and F₄ make no contribution to category determination of x.

Further, in practice, in step S102, the category of the current risk control event can be determined based on a plurality of decision trees, for example, a random forest. In such a case, category determination contributions can be determined on all the decision trees and are then added or averaged, and a value obtained through addition or averaging is used as the category determination contribution representation value.

Averaging is used as an example, formula 2 can be extended to obtain:

$$F {C}_{c} ( f ) = \frac{1}{\vert T \vert} {\sum }_{t ∈ T} F {C}_{c}^{( t )} ( f ) \qquad ( Formula 3 )$$

[symbol] denotes a random forest used for category determination, t denotes a decision tree in [symbol] , and FC_{c}^{(t)}(ƒ) is a category determination contribution representation value corresponding to decision tree t that is calculated based on formula 2.

Still further, in practice, for the decision tree, the number of sample risk control events gradually decreases when approaching to a leaf node. Consequently, probability estimation can be inaccurate, and the reliability of the determined category determination contribution representation value is affected. For such a problem, the solutions in the present application also provide a countermeasure. For example, a virtual sample risk control event can be set, to maintain the number of samples at a proper level.

The determining the category determination contribution representation value of the risk feature information of the current risk control event based on density change information of sample risk control events of a specified category that are before and after a specific node included on the decision path can include: setting a virtual sample risk control event; and determining the category determination contribution representation value of the risk feature information of the current risk control event based on density change information of sample risk control events and virtual sample risk control events of the specified category that are before and after the specific node included on the decision path.

The virtual sample risk control event can be set in a plurality of methods, for example, can be set based on a prior probability distribution, or can be set at random. The previous method is used as an example. The setting a virtual sample risk control event can include: setting the virtual sample risk control event based on a prior probability distribution assumed for the sample risk control events of the specified category.

For example, assume that the sample risk control event of the specified category is a case, and assume that a case probability p follows a prior Beta distribution:

$$\frac{Γ ( α + β )}{Γ ( α ) Γ ( β )} {{p}^{α - 1} ( 1 - p )}^{β - 1} , 0 < p < 1 .$$

An average value of

$$p is \frac{α}{α + β} ,$$

and a variance of p is

$$\frac{α β}{{( α + β )}^{2} ( α + β + 1 )} .$$

Assume that m sample risk control events are observed and there are z cases. A posterior distribution of the case probability p is a Beta distribution, and parameters are as follows:

α′=α+z, and β′=β+m−z.

An average value is

$$\frac{{α}^{′}}{{α}^{′} + {β}^{′}} = \frac{α + z}{α + β + m} . \qquad ( Formula 4 )$$

Therefore, assuming the prior Beta distribution is equivalent to setting α+β virtual sample events, and there are α cases. To improve the reliability, in practice, a case proportion of the virtual sample events can be set to be the same as an actual case proportion p₀ of sample events. Assume that m₀ virtual sample events are set in total.

α=m₀·p₀, and β=m₀·(1−p₀) (Formula 5)

3. A determining method for the feature dimension contribution representation value FC_{F}(ƒ). The example in FIG. 3 is still used for description. As described above, FC_{c}(ƒ) usually measures the contribution of the risk feature ƒ by using an increase of the case density after the sample risk control event is filtered by a node including the risk feature ƒ on the decision path on the decision tree, which is essentially a measurement method based on a path on the decision tree. Further, the contribution of the risk feature ƒ can be alternatively measured without using the path on the decision tree, for example, measured by using FC_{F}(ƒ).

The feature dimension contribution representation value of the risk feature information of the current risk control event can be determined in the following method: determining a plurality of sets that correspond to a risk feature corresponding to the risk feature information; determining a set in the plurality of sets that includes the risk feature information; and determining the feature dimension contribution representation value of the risk feature information based on a density of sample risk control events, of a specified category, corresponding to the set that includes the risk feature information, where any risk feature information corresponding to the risk feature belongs to at least one of the plurality of sets.

In practice, the risk feature can be a numerical variable, or can be a non-numerical variable. Correspondingly, the risk feature information can be a numerical value, or can be a non-numerical value.

When the risk feature is a numerical variable, the plurality of sets can be a plurality of numerical intervals obtained by dividing a value range of the risk feature, and each set is one of the numerical intervals.

For example, when the risk feature ƒ is a numerical variable, a numerical interval obtained through division for the risk feature ƒ is denoted as T_{F}(ƒ). The degree to which a case density of the current risk control event x in a numerical interval that includes the current risk control event x can be used as the feature dimension contribution representation value of the risk feature ƒ:

FC_{F}(ƒ)=P(y=C(x)|ƒ(x)∈T_{F}(ƒ))−P(y=C(x)) (Formula 6)

ƒ(x) denotes the risk feature information, of x, corresponding to the risk feature ƒ, and is a numerical value here. P(y=C(x)|ƒ∈T_{F}(ƒ)) denotes a case proportion of x in the numerical interval that includes x. P(y=C(x)) denotes a case proportion in all intervals.

Numerical interval division can be implemented based on a quantization algorithm. There can be a plurality of quantization algorithms, for example, uniform interval division or a single-variable decision tree.

When the risk feature is a non-numerical variable, the plurality of sets can be a plurality of non-numerical variable value sets obtained by classifying non-numerical variable values corresponding to the risk feature, and each set is one of the non-numerical variable value sets. The non-numerical variable can be a category (category) variable, a string variable, etc.

For another example, when the risk feature ƒ is a category (category) variable, a conditional probability of a value of ƒ(x) can be used to calculate the feature dimension contribution representation value, and the conditional probability can be calculated based on the previous case density. Details are as follows:

FC_{F}(ƒ)=P(y=C(x)|ƒ=C(x)).

4. A determining method for the feature anomaly representation value FO_{C}(ƒ). It can be learned from the previous description that when the category determination contribution representation value FC_{c}(ƒ) is determined, FO_{C}(ƒ) in a node is the same provided that FC_{c}(ƒ) is in a same branch of a same node on the decision tree. However, it should be considered that, for example, when ƒ>10 in a node, contributions are obviously different when ƒ=10.1 and ƒ=10000. FO_{C}(ƒ) is a contribution measurement factor for such a case, and FO_{C}(ƒ) can be used to adjust FC_{c}(ƒ).

In the present implementation of the present application, the feature anomaly representation value of the risk feature information of the current risk control event can be determined in the following method: determining the feature anomaly representation value of the risk feature information of the current risk control event based on a status of determining sample risk control events of a specified category on a specific node included on the decision path, where the specific node includes the risk feature corresponding to the risk feature information.

Further, there are a plurality of implementation solutions of the method in the previous paragraph. For example, the feature anomaly representation value can be determined based on a posterior probability.

FO_{C}(ƒ)=max[P(y=C(x)|ƒ≥ƒ(x)∩ƒ∈N(ƒ)),P(y=C(x)|ƒ<ƒ(x)∩ƒ∈N(ƒ))] (Formula 7)

N(ƒ) denotes space determined by the risk feature ƒ on the decision path. The decision path in FIG. 3 is used as an example, and N(F₁)=(F₁>1)∩(F₁>4)=F₁>4. In addition, an advantage of formula 7 is that FO_{C}(ƒ) and FC_{c}(ƒ) are on the same order of magnitude when FO_{C}(ƒ)∈[0,1].

In practice, the feature anomaly representation value can be used to adjust both FC_{c}(ƒ) and FC_{F}(ƒ). For distinguishing, a feature anomaly representation value used to adjust FC_{F}(ƒ) is denoted as FO_{F}(ƒ).

FO_{F}(ƒ) can be calculated in a similar method:

FO_{F}(ƒ)=max[P(y=C(x)|ƒ≥ƒ(x)∩ƒ∈T_{F}(ƒ)),P(y=C(x)|ƒ<ƒ(x)∩ƒ∈T_{F}(ƒ))] (Formula 8)

The previous separately describes in detail several factors that can be used to determine a contribution representation value of the risk feature information. The contribution representation value of the risk feature information can be determined in a plurality of methods based on a determined representation value of each factor. Two methods are listed: heuristic-based design and machine learning based on an annotated sample. The two methods are separately described.

The heuristic-based design means that the contribution representation value of the risk feature information can be obtained by comprehensively calculating the representation values of the previous factors by designing a proper formula. For example,

FC(ƒ)=FCₖ(ƒ)·[λ·FO_{F}(ƒ)·FC_{F}(ƒ)+(1−λ)·FO_{C}(ƒ)·FC_{C}(ƒ)] (Formula 9).

λ is an adjustable weight coefficient.

The machine learning based on an annotated sample mainly includes two main steps:

1. Obtain annotated samples. Some cases and non-cases can be sampled, and experts can rate correlation between risk features of these samples or correlation between these samples. As such, an annotated data set is obtained. The annotated data set includes a risk feature ƒ_{i,j} of a sample xᵢ, and a correlation label y_{i,j}.

A learning method: When there is an annotated data set {(xᵢ, ƒ_{i,j}, y_{i,j}),1≤i≤N,1≤j≤K}, based on the representation values of the previous factors, the sample xᵢ and the risk feature ƒ_{i,j} of the sample xᵢ can form a description vector:

[FCₖ(ƒ_{i,j}),FO_{F}(ƒ_{i,j}),FC_{F}(ƒ_{i,j}),FO_{C}(ƒ_{i,j}),FC_{c}(ƒ_{i,j})]. This is a typical learning to rank (learning to rank) problem. A proper ranking model, for example, rank-SVM can be used to fit the correlation label y_{i,j}, to obtain a contribution representation value of corresponding risk feature information.

Further, in step S103, the obtaining evidence information corresponding to a determination result can include: ranking the risk feature information based on the determined contribution representation values of the risk feature information; and obtaining, based on a ranking result, evidence information corresponding to risk feature information with top N contribution representation values, and using the evidence information as the evidence information corresponding to the determination result. Alternatively, the risk feature information may not be ranked. Instead, a threshold of the contribution representation value can be predetermined, and evidence information corresponding to risk feature information that has a contribution representation value not less than the threshold is obtained and used as the evidence information corresponding to the determination result.

In practice, after the evidence information is obtained, the evidence information can be processed based on a specific format template, so that the evidence information is used as a part of the finally generated case closing information. The format template is not limited in the present application, and can be a text format template, or can be a table data format template, a graph data format template, etc.

In the present implementation of the present application, when the category of the current risk control event is determined based on the decision tree, a confidence level of the determination result can be further calculated by using a corresponding solution.

If the confidence level of the determination result is low, the reliability of subsequent steps performed based on the determination result is also hard to ensure. Therefore, a related parameter can be adjusted and the category of the current risk control event is re-determined, until the confidence level of the determination result reaches a relatively high degree. Alternatively, the category of the current risk control event is determined manually instead. A specific degree that the confidence level needs to reach can be predefined by using a specified threshold.

Based on the analysis in the previous paragraph, in step S104, before the case closing information of the current risk control event is generated, the following step can be further performed: calculating a confidence level of the determination result; and determining that the confidence level of the determination result is not less than a specified threshold.

There are several solutions for calculating the confidence level. For example, for a leaf node on which the current risk control event falls on the decision path, a posterior probability of correctly classifying sample risk control events that fall on the leaf node is determined as the confidence level. For another example, for a random forest, a proportion of the maximum number of results obtained by determining the current risk control event on decision trees in the random forest is calculated as the confidence level.

In the present implementation of the present application, in step S104, the case closing information can include the determination result and the evidence information, and can further include other related information such as the confidence level. Usually, information such as the determination result and the evidence information can be assembled based on a predetermined case closing information template, to generate the case closing information. The case closing information template can be described based on a specific application scenario. Implementations are not limited in the present application.

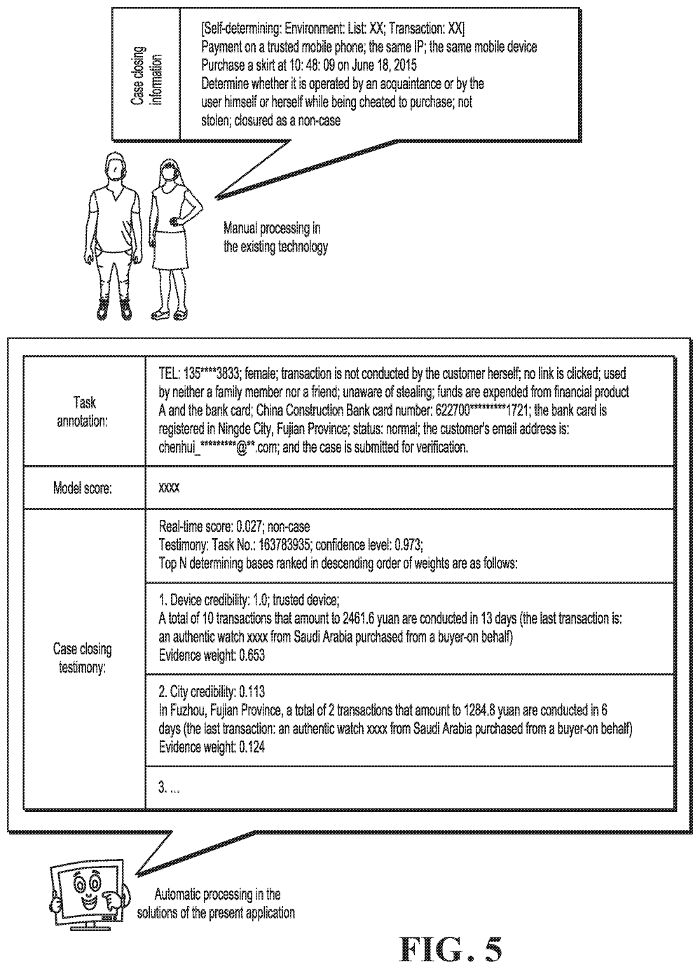

More intuitively, the present implementation of the present application further provides a schematic diagram illustrating a comparison between case closing information generated based on the previous risk control event automatic processing method and case closing information in the existing technology. As shown in FIG. 5.

FIG. 5 includes two sub-diagrams: “manual processing in the existing technology” and “automatic processing in the solutions of the present application”.

It can be seen from the upper side of FIG. 5 that in the existing technology, because manual processing is performed, case closing information is simple, a current risk control event “a user purchases a skirt at 10:48:09 on Jun. 18, 2015” is simply described, and a determination result “non-case” is provided. The case closing information includes little information.

It can be seen from the lower side of FIG. 5 that based on the solutions in the present application, detailed case closing information is generated, and the case closing information includes three parts: task annotation, model score, and case closing testimony.

The “task annotation” describes detailed information of the current risk control event, for example, a mobile phone number of a user, a gender of the user, an email address of the user, some scenario information (for example, used by neither a family member nor a friend) obtained by directly communicating with the user, a related financial product and bank card number, a location at which the bank card is registered, and a status of the bank card.

The “model score” describes scores of some models used to implement the solutions of the present application, and the score can measure a function or performance of a model to some extent. The model can be, for example, a model used for the classifier, a model used to determine the contribution representation value, and a model used to obtain the evidence information.

The “case closing testimony” describes the determination result of the current risk control event and the confidence level of the determination result, some risk feature information used for determining, a contribution representation value of the risk feature information, corresponding evidence information, etc.

When the current risk control event is determined as a non-case, and the confidence level is 0.973. The risk feature information used for determining includes “device credibility”, “city credibility”, etc. The “device credibility” is used as an example, a contribution representation value of the “device credibility” can be an evidence weight 0.653, and corresponding evidence information is “a total of 10 transactions that amount to 2461.6 yuan are conducted in 13 days (the last transaction is: an authentic watch xxxx from Saudi Arabia purchased from a buyer-on behalf)”. The evidence information indicates that the user has conducted a large number of transactions by using the current device. It can be inferred that the current device is a device frequently used by the user, and therefore, there is a high probability that the current device is a trusted device.

Based on the comparison between the existing technology and the solution in the present application in FIG. 5, it can be seen that by using the solution in the present application, labor can be saved, and a speed of processing the risk control event is accelerated; a variety of risk feature information is considered more comprehensively, to determine the risk control event; and in addition, the evidence information used to support the determination result can be conveniently provided, and therefore, it is convenient to verify the reliability of the determination result of the risk control event.

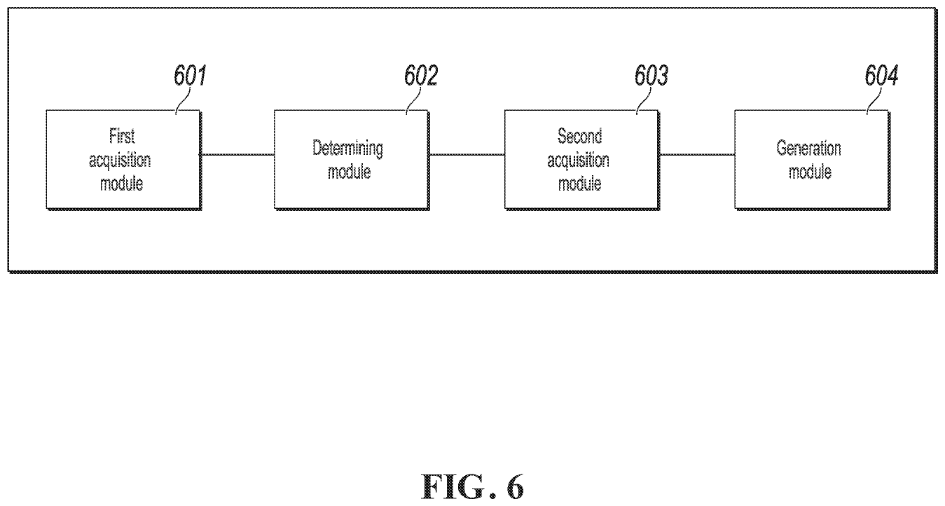

The risk control event automatic processing method provided in the present implementation of the present application is described above. As shown in FIG. 6, based on the same invention idea, an implementation of the present application further provides a corresponding apparatus.

FIG. 6 is a schematic structural diagram illustrating a risk control event automatic processing apparatus corresponding to FIG. 1, according to an implementation of the present application. The apparatus can be located on an execution body of the procedure in FIG. 1, and includes: a first acquisition module 601, configured to obtain each piece of risk feature information of a current risk control event; a determining module 602, configured to determine a category of the current risk control event based on the risk feature information; a second acquisition module 603, configured to obtain evidence information corresponding to a determination result; and a generation module 604, configured to generate case closing information of the current risk control event based on the determination result and the evidence information.

Optionally, the determining module 602 determines the category of the current risk control event based on the risk feature information, including: obtaining, by the determining module 602, a classifier obtained by performing training based on risk feature information of sample risk control events; and determining the category of the current risk control event by classifying the current risk control event based on the classifier and the risk feature information.

Optionally, the second acquisition module 603 obtains the evidence information corresponding to the determination result, including: determining, by the second acquisition module 603, contribution representation values of the risk feature information; and obtaining the evidence information corresponding to the determination result based on the contribution representation values and the risk feature information corresponding to the contribution representation values.

Optionally, the determining, by the second acquisition module 603, contribution representation values of the risk feature information includes: determining, by the second acquisition module 603, at least one of the following specific representation values of the risk feature information: an evidence importance representation value, a category determination contribution representation value, a feature dimension contribution representation value, and a feature anomaly representation value; and determining the contribution representation values of the risk feature information based on determined specific representation values.

Optionally, the classifier performs classification by using a decision tree, and at least some nodes on the decision tree include risk features corresponding to the risk feature information.

Optionally, the second acquisition module 603 determines the category determination contribution representation value of the risk feature information of the current risk control event in the following method: determining, by the second acquisition module 603, a decision path corresponding to the determination result on the decision tree; and determining the category determination contribution representation value of the risk feature information of the current risk control event based on density change information of sample risk control events of a specified category that are before and after a specific node included on the decision path, where the specific node includes the risk feature corresponding to the risk feature information.

Optionally, the determining, by the second acquisition module 603, the category determination contribution representation value of the risk feature information of the current risk control event based on density change information of sample risk control events of a specified category that are before and after a specific node included on the decision path includes: setting, by the second acquisition module 603, a virtual sample risk control event; and determining the category determination contribution representation value of the risk feature information of the current risk control event based on density change information of sample risk control events and virtual sample risk control events of the specified category that are before and after the specific node included on the decision path.

Optionally, the setting, by the second acquisition module 603, a virtual sample risk control event includes: setting, by the second acquisition module 603, the virtual sample risk control event based on a prior probability distribution assumed for the sample risk control events of the specified category.

Optionally, the second acquisition module 603 determines the feature dimension contribution representation value of the risk feature information of the current risk control event in the following method: determining, by the second acquisition module 603, a plurality of sets that correspond to a risk feature corresponding to the risk feature information; determining a set in the plurality of sets that includes the risk feature information; and determining the feature dimension contribution representation value of the risk feature information based on a density of sample risk control events, of a specified category, corresponding to the set that includes the risk feature information, where any risk feature information corresponding to the risk feature belongs to at least one of the plurality of sets.

Optionally, the second acquisition module 603 determines the feature anomaly representation value of the risk feature information of the current risk control event in the following method: determining, by the second acquisition module 603, the feature anomaly representation value of the risk feature information of the current risk control event based on a status of determining sample risk control events of a specified category on a specific node included on the decision path, where the specific node includes the risk feature corresponding to the risk feature information.

Optionally, the second acquisition module 603 obtains the evidence information corresponding to the determination result, including: ranking, by the second acquisition module 603, the risk feature information based on the determined contribution representation values of the risk feature information; and obtaining, based on a ranking result, evidence information corresponding to risk feature information with top N contribution representation values, and using the evidence information as the evidence information corresponding to the determination result.

Optionally, before generating the case closing information of the current risk control event, the generation module 604 calculates a confidence level of the determination result, and determines that the confidence level of the determination result is not less than a specified threshold.

Optionally, the category of the current risk control event is a case or a non-case.

The apparatus provided in the present implementation of the present application is in a one-to-one correspondence with the method provided in the present implementation of the present application. Therefore, the apparatus and the method corresponding to the apparatus have similar beneficial technical effects. A beneficial technical effect of the method has been described above in detail, and therefore a beneficial technical effect of the corresponding apparatus is omitted here for simplicity.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through component programming. The designer performs programming to “integrate” a digital system to a PLD without requesting a chip manufacturer to design and produce an application-specific integrated circuit chip. In addition, at present, instead of manually manufacturing an integrated chip, this category of programming is mostly implemented by using “logic compiler (logic compiler)” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. A memory controller can also be implemented as a part of the control logic of the memory. A person skilled in the art also knows that, in addition to implementing the controller by using the computer readable program code only, method steps can be logically programmed to allow the controller to implement the same function in forms of the logic gate, the switch, the application-specific integrated circuit, the programmable logic controller, and the built-in microcontroller. Therefore, the controller can be considered as a hardware component, and apparatuses configured to implement various functions in the controller can also be considered as a structure inside the hardware component. Or the apparatuses configured to implement various functions can even be considered as both software modules implementing the method and a structure inside the hardware component.

The system, apparatus, module, or unit illustrated in the previous implementations can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present application is implemented, functions of the units can be implemented in one or more pieces of software and/or hardware.

A person skilled in the art should understand that an implementation of the present disclosure can be provided as a method, a system, or a computer program product. Therefore, the present disclosure can use a form of hardware only implementations, software only implementations, or implementations with a combination of software and hardware. Moreover, the present disclosure can use a form of a computer program product that is implemented on one or more computer-usable storage media (including but not limited to a disk memory, a CD-ROM, an optical memory, etc.) that include computer-usable program code.

The present disclosure is described with reference to the flowcharts and/or block diagrams of the method, the device (system), and the computer program product based on the implementations of the present disclosure. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can be stored in a computer readable memory that can instruct the computer or the another programmable data processing device to work in a specific way, so that the instructions stored in the computer readable memory generate an artifact that includes an instruction apparatus. The instruction apparatus implements a specific function in one or more procedures in the flowcharts and/or in one or more blocks in the block diagrams.

These computer program instructions can be loaded onto the computer or another programmable data processing device, so that a series of operation steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), one or more input/output interfaces, one or more network interfaces, and one or more memories.

The memory can include a non-persistent memory, a random access memory (RAM), a nonvolatile memory, and/or another form in the computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a parameter random access memory (PRAM), a static random access memory (SRAM), a dynamic random access memory (DRAM), another category of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible to the computing device. Based on the definition in the present specification, the computer readable medium does not include transitory computer readable media (transitory media) such as a modulated data signal and carrier.

It is worthwhile to further note that, the terms “include”, “comprise”, or their any other variants are intended to cover a non-exclusive inclusion, so a process, a method, a commodity, or a device that includes a list of elements not only includes those elements but also includes other elements which are not expressly listed, or further includes elements inherent to such a process, method, commodity, or device. Without more constraints, an element preceded by “includes a . . . ” does not preclude the existence of additional identical elements in the process, method, commodity, or device that includes the element.

The present application can be described in the general context of computer executable instructions executed by a computer, for example, a program module. Usually, the program module includes a routine, a program, an object, a component, a data structure, etc. executing a task or implementing an abstract data category. The present application can also be practiced in distributed computing environments. In the distributed computing environments, tasks are performed by remote processing devices connected through a communications network. In a distributed computing environment, the program module can be located in both local and remote computer storage media including storage devices.

The implementations in the present specification are described in a progressive way. For same or similar parts of the implementations, references can be made to the implementations. Each implementation focuses on a difference from other implementations. Particularly, a system implementation is basically similar to a method implementation, and therefore, is described briefly. For related parts, references can be made to related descriptions in the method implementation.

The previous implementations are implementations of the present application, and are not intended to limit the present application. A person skilled in the art can make various modifications and changes to the present application. Any modification, equivalent replacement, or improvement made without departing from the spirit and principle of the present application shall fall within the scope of the claims in the present application.

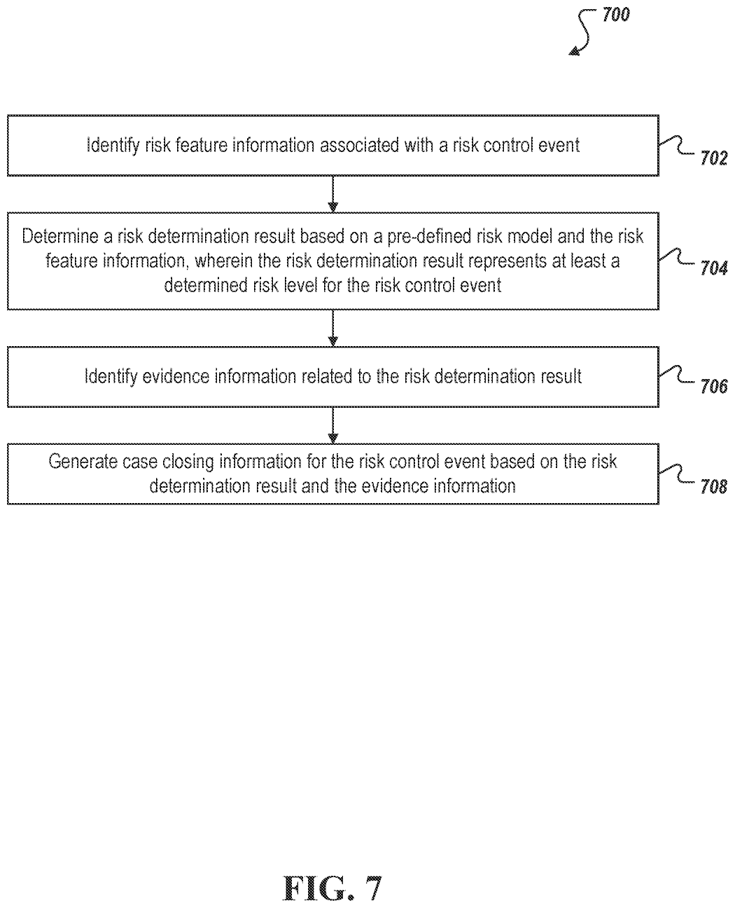

FIG. 7 is a flowchart illustrating an example of a computer-implemented method 700 for processing a risk control event, according to an implementation of the present disclosure. For clarity of presentation, the description that follows generally describes method 700 in the context of the other figures in this description. However, it will be understood that method 700 can be performed, for example, by any system, environment, software, and hardware, or a combination of systems, environments, software, and hardware, as appropriate. In some implementations, various steps of method 700 can be run in parallel, in combination, in loops, or in any order.

At 702, risk feature information associated with a risk control event is identified. At 704, a risk determination result based on a pre-defined risk model and the risk feature information is determined, wherein the risk determination result represents at least a determined risk level for the risk control event. In some cases, the risk determination result includes a category for the risk control event. In some examples, the category for the risk control event is a case or a non-case. In some implementations, determining a risk determination result based on a pre-defined risk model and the risk feature information comprises identifying a classifier obtained by performing training based on risk feature information of sample risk control events; and determining the risk determination result by classifying the risk control event based on the classifier and the risk feature information.

At 706, evidence information related to the risk determination result is identified. In some cases, identifying evidence information related to the risk determination result comprises determining contribution representation values of the risk feature information; and identifying the evidence information related to the risk determination result based on the contribution representation values and the risk feature information corresponding to the contribution representation values. In some implementations, identifying evidence information related to the risk determination result comprises determining contribution representation values of the risk feature information; identifying a ranking result by ranking the risk feature information based on the contribution representation values of the risk feature information; and identifying, based on the ranking result, evidence information corresponding to the risk feature information having a ranking result that satisfies a particular criteria, and using the evidence information as the evidence information related to the risk determination result.

In some cases, determining contribution representation values of the risk feature information comprises determining at least one of the following specific representation values of the risk feature information: an evidence importance representation value, a category determination contribution representation value, a feature dimension contribution representation value, or a feature anomaly representation value; and determining the contribution representation values of the risk feature information based on the specific representation values. In some examples, the feature dimension contribution representation value of the risk feature information of the risk control event is determined in the following method: determining a plurality of sets that correspond to a risk feature corresponding to the risk feature information; determining a set in the plurality of sets that comprises the risk feature information; and determining the feature dimension contribution representation value of the risk feature information based on a density of sample risk control events, of a specified category, corresponding to the set that comprises the risk feature information; and wherein any risk feature information corresponding to the risk feature belongs to at least one of the plurality of sets.

In some cases, the classifier performs classification by using a decision tree, and wherein at least some nodes on the decision tree comprise a risk feature corresponding to the risk feature information. In some examples, the feature anomaly representation value of the risk feature information of the risk control event is determined in the following method: determining a decision path corresponding to the risk determination result on the decision tree; and determining the feature anomaly representation value of the risk feature information of the risk control event based on a status of determining sample risk control events of a specified category on a specific node comprised on the decision path, wherein the specific node comprises the risk feature corresponding to the risk feature information. In some implementations, the category determination contribution representation value of the risk feature information of the risk control event is determined in the following method: determining a decision path corresponding to the risk determination result on the decision tree; and determining the category determination contribution representation value of the risk feature information of the risk control event based on density change information of sample risk control events of a specified category that are before and after a specific node comprised on the decision path, wherein the specific node comprises the risk feature corresponding to the risk feature information. In some cases, determining the category determination contribution representation value of the risk feature information of the risk control event based on density change information of sample risk control events of a specified category that are before and after a specific node comprised on the decision path comprises: identifying a set of virtual sample risk control events; and determining the category determination contribution representation value of the risk feature information of the risk control event based on density change information of sample risk control events and the set of virtual sample risk control events of the specified category that are before and after the specific node comprised on the decision path. In some implementations, identifying a set of virtual sample risk control events comprises identifying a set of virtual sample risk control events based on a prior probability distribution assumed for the sample risk control events of the specified category.

At 708, case closing information for the risk control event based on the risk determination result and the evidence information is generated. In some implementations, before generating case closing information for the risk control event, the method further comprises identifying a confidence level of the risk determination result; and determining that the confidence level of the risk determination result is not less than a specified threshold.

The techniques described herein can produce one or more technical effects. For example, the techniques can enable a risk control platform to automatically determine a risk level for a risk control event, identify evidence information, and generate case closing information. This automatic processing can enable the risk control platform to resolve a risk control event without manual analysis. This can increase case closing efficiency and improve user experiences for the risk control platform. The techniques can also enable a risk control platform to give more reliable risk determination results of risk control events than manual analysis. A computer can generally process a large number of cases with fewer mistakes than humans, especially under heavy workload.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

1.-20. (canceled)

21. A computer-implemented method comprising:
identifying a plurality of pieces of feature information associated with an event;
identifying a classifier that has been obtained by performing machine learning training based on sample feature information of sample events;
determining a classification determination result of the event based on the classifier and the plurality of pieces of feature information;
determining specific representation values of the plurality of pieces of feature information;
identifying, based on the specific representation values of the plurality of pieces of feature information, one or more pieces of evidence information related to the classification determination result; and
generating case closing information for the event based on the classification determination result and the one or more pieces of evidence information.

22. The method according to claim 21, wherein the classification determination result of the event specifies whether the event is a case or a non-case.

23. The method according to claim 21, wherein before generating the case closing information for the event, the method further comprises:
identifying a confidence level of the classification determination result; and
determining that the confidence level of the classification determination result is not less than a specified threshold.

24. The method according to claim 21, wherein determining the specific representation values of the plurality of pieces of feature information comprises:
determining contribution representation values of the plurality of pieces of feature information; and
identifying the one or more pieces of evidence information related to the classification determination result based on the contribution representation values and the plurality of pieces of feature information corresponding to the contribution representation values.

25. The method according to claim 24, wherein identifying the one or more pieces of evidence information related to the classification determination result comprises:
identifying a ranking result by ranking the plurality of pieces of feature information based on the contribution representation values of the plurality of pieces of feature information;
identifying, based on the ranking result, one or more pieces of evidence information corresponding to one or more pieces of feature information that each have a ranking result that satisfies a particular criteria; and
using the one or more pieces of evidence information as the one or more pieces of evidence information related to the classification determination result.

26. The method according to claim 24, wherein determining the contribution representation values of the plurality of pieces of feature information comprises, for each feature information of the plurality of pieces of feature information:
determining at least one of the following specific representation values of the feature information: an evidence importance representation value, a category determination contribution representation value, a feature dimension contribution representation value, or a feature anomaly representation value; and
determining the contribution representation values of the feature information based on the specific representation values.

27. The method according to claim 26, wherein the feature dimension contribution representation value of the feature information of the event is determined based on:
determining a plurality of sets that correspond to a feature corresponding to the feature information;
determining a set in the plurality of sets that comprises the feature information; and
determining the feature dimension contribution representation value of the feature information based on a density of sample events within a specified category that corresponds to the set that includes the feature information, wherein any feature information corresponding to the feature belongs to at least one of the plurality of sets.

28. The method according to claim 27, wherein the feature is a numerical variable, and wherein the set is a numerical interval.

29. The method according to claim 27, wherein the feature is a non-numerical variable, and wherein the set is a non-numerical variable value set.

30. The method according to claim 27, wherein the classifier performs classification by using a plurality of decision trees, and wherein at least some nodes on the plurality of decision trees include a feature corresponding to the feature information.

31. The method according to claim 30, wherein the feature anomaly representation value of the feature information of the event is determined based on:
determining a decision path corresponding to the classification determination result on the plurality of decision trees; and
determining the feature anomaly representation value of the feature information of the event based on a status of determining sample events within a specified category on a specific node included on the decision path, wherein the specific node includes the feature corresponding to the feature information.

32. The method according to claim 30, wherein the category determination contribution representation value of the feature information of the event is determined based on:
determining a decision path corresponding to the classification determination result on the plurality of decision trees; and
determining the category determination contribution representation value of the feature information of the event based on density change information of sample events within a specified category that are before and after a specific node included on the decision path, wherein the specific node includes the feature corresponding to the feature information.

33. The method according to claim 32, wherein determining the category determination contribution representation value of the feature information of the event based on density change information comprises:
identifying a set of virtual sample events; and
determining the category determination contribution representation value of the feature information of the event based on density change information of sample events and the set of virtual sample events within the specified category that are before and after the specific node included on the decision path.

34. The method according to claim 33, wherein identifying the set of virtual sample events comprises:
identifying a set of virtual sample events based on a prior probability distribution assumed for the sample events of the specified category.

35. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
identifying a plurality of pieces of feature information associated with an event;
identifying a classifier that has been obtained by performing machine learning training based on sample feature information of sample events;
determining a classification determination result of the event based on the classifier and the plurality of pieces of feature information;
determining specific representation values of the plurality of pieces of feature information;
identifying, based on the specific representation values of the plurality of pieces of feature information, one or more pieces of evidence information related to the classification determination result; and
generating case closing information for the event based on the classification determination result and the one or more pieces of evidence information.

36. The system according to claim 35, wherein determining the specific representation values of the plurality of pieces of feature information comprises:
determining contribution representation values of the plurality of pieces of feature information; and
identifying the one or more pieces of evidence information related to the classification determination result based on the contribution representation values and the plurality of pieces of feature information corresponding to the contribution representation values.

37. The system according to claim 36, wherein identifying the one or more pieces of evidence information related to the classification determination result comprises:
identifying a ranking result by ranking the plurality of pieces of feature information based on the contribution representation values of the plurality of pieces of feature information;
identifying, based on the ranking result, one or more pieces of evidence information corresponding to one or more pieces of feature information that each have a ranking result that satisfies a particular criteria; and
using the one or more pieces of evidence information as the one or more pieces of evidence information related to the classification determination result.

38. The system according to claim 36, wherein determining the contribution representation values of the plurality of pieces of feature information comprises, for each feature information of the plurality of pieces of feature information:
determining at least one of the following specific representation values of the feature information: an evidence importance representation value, a category determination contribution representation value, a feature dimension contribution representation value, or a feature anomaly representation value; and
determining the contribution representation values of the feature information based on the specific representation values.

39. The system according to claim 38, wherein the feature dimension contribution representation value of the feature information of the event is determined based on:
determining a plurality of sets that correspond to a feature corresponding to the feature information;
determining a set in the plurality of sets that comprises the feature information; and
determining the feature dimension contribution representation value of the feature information based on a density of sample events within a specified category that corresponds to the set that includes the feature information, wherein any feature information corresponding to the feature belongs to at least one of the plurality of sets.

40. A non-transitory, computer-readable medium storing one or more instructions executable by a computer system to perform operations comprising:
identifying a plurality of pieces of feature information associated with an event;
identifying a classifier that has been obtained by performing machine learning training based on sample feature information of sample events;
determining a classification determination result of the event based on the classifier and the plurality of pieces of feature information;
determining specific representation values of the plurality of pieces of feature information;
identifying, based on the specific representation values of the plurality of pieces of feature information, one or more pieces of evidence information related to the classification determination result; and
generating case closing information for the event based on the classification determination result and the one or more pieces of evidence information.
